(19) United States
(12) Patent Application Publication
(10) Pub. No.: US 2018/0043565 A1
(43) Pub. Date: Feb. 15, 2018

(54) PALLET DISMANTLING WITH GUIDED ALIGNMENT

(71) Applicant: Innovative Pallet Solutions, L.L.C., South Jordan, UT (US)

(72) Inventors: John Fenley, Provo, UT (US); Joseph Sanchez, South Jordan, UT (US)

(21) Appl. No.: 15/672,038

(22) Filed: Aug. 8, 2017

Related U.S. Application Data
(60) Provisional application No. 62/372,609, filed on Aug. 9, 2016.

(51) Int. Cl. B27B 13/10; B27B 13/02

(52) U.S. Cl. CPC B27B 13/10; B27B 13/02; B27B 5/29

(57) ABSTRACT

The present disclosure illustrates pallet dismantling systems and methods. The disclosure provides pallet dismantling systems that use alignment forks, guides, and cutting tools to simplify the dismantling of pallets. The alignment fork comprising cantilevers with contact surfaces that abut a deckboard surface coupled to one or more stringers of the received pallet causing a junction between the deckboard surface and the one or more stringers to be in-line with the contact surfaces. Further, the dismantling system may comprise a cutting tool positioned planar to the contact surfaces of the cantilevers at a point along the alignment fork, the cutting tool to separate the one or more deckboards abutting the contact surfaces from the one or more stringers.

### CROSS-REFERENCE TO RELATED APPLICATIONS

This application claims the benefit of U.S. Provisional Application No. 62/372,609, filed Aug. 9, 2016, titled “PALLET DECONSTRUCTION SYSTEMS AND METHODS,” which is hereby incorporated by reference herein in its entirety.

### TECHNICAL FIELD

This disclosure generally relates to systems and methods for dismantling pallets. More particularly, this disclosure provides systems and methods for aligning dismantling blades with the coupling between the deckboards and the stringers.

### BACKGROUND

Bandsaw pallet dismantlers have proven to be reliable and efficient tools in the pallet dismantling and recycling industry, but blade alignment issues and the manual labor and skill required to operate them have been continuing issues. This has led to many efforts to develop better mechanisms, machines, approaches, methods and related devices for dismantling pallets. However, these solutions still have serious drawbacks such as operating at a low speed, damaging reclaimed boards, needing skilled manual operation, requiring several passes through the device, or generally providing overcomplicated robotic solutions. A general purpose pallet dismantler that can work on several different sizes and styles of pallets without skilled operation and adjustment or complicated sensors may be desirable.

### BRIEF DESCRIPTION OF THE DRAWINGS

Non-limiting and non-exhaustive embodiments of the disclosure are described, including various embodiments of the disclosure with reference to the figures, in which:

FIG. 1 illustrates a side view of an alignment fork for a pallet dismantling system, according to one exemplary embodiment.

FIG. 2 illustrates a perspective view of a pallet dismantling system with alignment forks to guide a pallet, according to one exemplary embodiment.

FIG. 3A illustrates a perspective view of an alignment fork to retrofit existing pallet dismantling systems, according to one exemplary embodiment.

FIG. 3B illustrates a perspective view of an alignment fork positioned on an existing pallet dismantling system, according to one exemplary embodiment.

FIG. 4A illustrates a front view of an exemplary guide chute for a pallet dismantling system, wherein a partially dismantled pallet is tightly fitted within the chute.

FIG. 4B illustrates a front view of an exemplary guide chute for a pallet dismantling system, wherein a partially dismantled pallet is loosely fitted within the chute, and vertical skids are securing the partially dismantled pallet against the chute.

FIG. 4C illustrates a front view of an exemplary guide chute for a pallet dismantling system, wherein a partially dismantled pallet is tightly fitted within the chute, and a lateral skid is securing the partially dismantled pallet against the chute.

FIG. 4D illustrates a front view of an exemplary guide chute for a pallet dismantling system, wherein a partially dismantled pallet is tightly fitted within the chute, and actuators are positioned around a stringer of the partially dismantled pallet, and a broad skid is securing the partially dismantled pallet against the chute.

FIG. 5 illustrates an automated pallet dismantling system, according to one exemplary embodiment.

FIG. 6 illustrates an automated pallet dismantling system with a pivoting arm actuator, according to one exemplary embodiment.

FIG. 7 illustrates a gravity fed pallet dismantling system, according to one exemplary embodiment.

FIGS. 8A-8C illustrate a static pallet dismantling system, according to one exemplary embodiment.

In the following description, numerous specific details are provided for a thorough understanding of the various embodiments disclosed herein. The systems and methods disclosed herein can be practiced without one or more of the specific details, or with other methods, components, materials, etc. In addition, in some cases, well-known structures, materials, or operations may not be shown or described in detail in order to avoid obscuring aspects of the disclosure. Furthermore, the described features, structures, or characteristics may be combined in any suitable manner in one or more alternative embodiments.

### DETAILED DESCRIPTION

The present disclosure provides systems and methods for pallet dismantling. According to various embodiments, the pallet dismantling system separates the deckboards, blocks, and/or stringers of a pallet. A pallet dismantling system may comprise an alignment fork, a base, and a cutting tool.

The alignment fork may receive a pallet. The alignment fork may include two cantilevers positioned on a horizontal plane. The bottom of the deckboards of the received pallet may abut a contact surface of the alignment fork, and one or more stringers of the received pallet may extend through the horizontal plane. The frame may be attached to one end of the alignment fork to support the alignment fork in an elevated position. The frame may also have a large opening to allow a pallet to pass through the frame. The cutting tool may separate the deckboards. The cutting tool may be positioned planar to the contact surface of the alignment fork. A collection area may receive and retain separated pieces of the pallet.

In some embodiments, a guide may align the cutting tool with a coupling between the deckboards and the stringers. A guide may be a divot, cutaway, opening, or aperture. The guide may provide a visual indication to an operator of where the cutting tool should be placed. Further, the guide may allow an operator to adjust a cutting tool in a vertical and/or horizontal direction.

In other embodiments, a specific “guide” may not be needed or included. In such an embodiment, the cutting tool may be aligned with the contact surface of the alignment fork. This may position the cutting tool to be in line with the coupling between the deckboards in contact with the alignment fork and the stringers.

In some embodiments, guide chutes may be used. A guide chute may surround the profile of a partially dismantled pallet. A partially dismantled pallet is a pallet that has one side of deckboards removed.

An operator may separate the deckboards on one side of the pallet by completing a pass. A pass occurs when the entire pallet has passed over the cutting tool. Further, a pallet may be passed through the pallet dismantling system, meaning the pallet may be collected on the side opposite the receiving end of the pallet dismantling system.

The pallet dismantling system may be used to separate both sides of deckboards from the stringers. In one embodiment, cutting tools may be on both sides of the alignment fork. In such an embodiment, the pallet dismantling system may completely disassemble the pallet in a single pass. In another embodiment, a pallet dismantling system may use a single cutting tool to remove both sides of deckboards. For example, an operator may pass the pallet through the pallet dismantling system once then flip the pallet and make another pass. In yet other embodiments, two alignment forks, each with a single cutting tool, may be used to remove both sides of deckboards.

In one embodiment clamps, skids, conveyer belts, and actuators may move the pallet through the pallet dismantling system. In another embodiment an operator may move the pallet through the pallet dismantling system. In an operator assisted embodiment, skids, conveyor belts, and actuators may assist an operator in moving the pallet through the pallet dismantling system.

Cutting tools may be any powered or unpowered means for separating and/or removing materials at a specified location. Cutting tools may include a sharp edge, a bandsaw, a reciprocating saw, a powered hacksaw, a friction cutting saw, an abrasive a water jet, a plasma cutter, a rolling cutter, a circular saw, or an abrasive cutoff disk. The pallet dismantling system may record data about the status of the blade, its condition, and efficiency. The pallet dismantling system may inform an operator of needed maintenance based on the recorded data.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. In particular, an “embodiment” may be a system, an article of manufacture, such as a computer-readable storage medium, a method, and/or a product of a process.

The phrases “connected to” and “in communication with” refer to any form of interaction between two or more components, including mechanical, electrical, magnetic, and electromagnetic interaction. Two components may be connected to each other even though they are not in direct contact with each other and even though there may be intermediary devices between the two components.

A pallet as described herein may include top deckboards, stringers, and bottom deckboards. The top and bottom deckboards may be coupled to the stringers at a junction via screws, nails, glue, clamps, bolts, adhesives, or any other suitable method or mechanism. Although the pallets described herein may include only top deckboards, bottom deckboards, and stringers, it should be understood that the present invention may be used with a variety of pallets; for example, with pallets that may have blocks and/or thin stringers to couple the top and bottom deckboards.

Some of the infrastructure that can be used with embodiments disclosed herein is already available, such as: general-purpose computers, computer programming tools and techniques, digital storage media, and communications networks. A computer may include a processor such as a microprocessor, microcontroller, logic circuitry, or the like. The processor may include a special purpose processing device such as an ASIC, PAL, PLA, PLD, Field Programmable Gate Array, or other customized or programmable device. The computer may also include a computer-readable storage device such as non-volatile memory, static RAM, dynamic RAM, ROM, CD-ROM, disk, tape, magnetic, optical, flash memory, or other computer-readable storage medium.

Various input devices and/or output devices may be utilized in conjunction with the presently described pallet dismantling system. Exemplary input devices include, but are not limited to, a keyboard, mouse, touch screen, light pen, tablet, microphone, sensor, or other hardware with accompanying firmware and/or software. Exemplary output devices include, but are not limited to, a monitor or other display, printer, switch, signal line, or other hardware with accompanying firmware and/or software.

The embodiments of the disclosure will be best understood by reference to the drawings, wherein like parts are designated by like numerals throughout. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified.

Aspects of certain embodiments described herein may be implemented as software modules or components. As used herein, a software module or component may include any type of computer instruction or computer executable code located within or on a computer-readable storage medium. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a computer-readable storage medium, which together implement the described functionality of the module. Indeed, a module may comprise a single instruction or many instructions, and may be distributed over several different code segments, among different programs, and across several computer-readable storage media. Some embodiments may be practiced in a distributed computing environment where tasks are performed by a remote processing device linked through a communications network. In a distributed computing environment, software modules may be located in local and/or remote computer-readable storage media. In addition, data being tied or rendered together in a database record may be resident in the same computer-readable storage medium, or across several computer-readable storage media, and may be linked together in fields of a record in a database across a network.

The software modules described herein tangibly embody a program, functions, and/or instructions that are executable by computer(s) to perform tasks as described herein. Suitable software, as applicable, may be provided using the teachings presented herein and programming languages and tools, such as XML, Java, Pascal, C++, C, database languages, APIs, SDKs, assembly, firmware, microcode, and/or other languages and tools. Additionally, software, firmware, and hardware may be interchangeably used to implement a given function.

In some cases, well-known features, structures or operations are not shown or described in detail. Furthermore, the described features, structures, or operations may be combined in any suitable manner in one or more embodiments. It will also be readily understood that the components of the embodiments as generally described and illustrated in the figures herein could be arranged and designed in a wide variety of different configurations.

In the following description, numerous details are provided to give a thorough understanding of various embodiments; however, the embodiments disclosed herein can be practiced without one or more of the specific details, or with other methods, components, materials, etc. In other instances, well-known structures, materials, or operations are not shown or described in detail to avoid obscuring aspects of this disclosure.

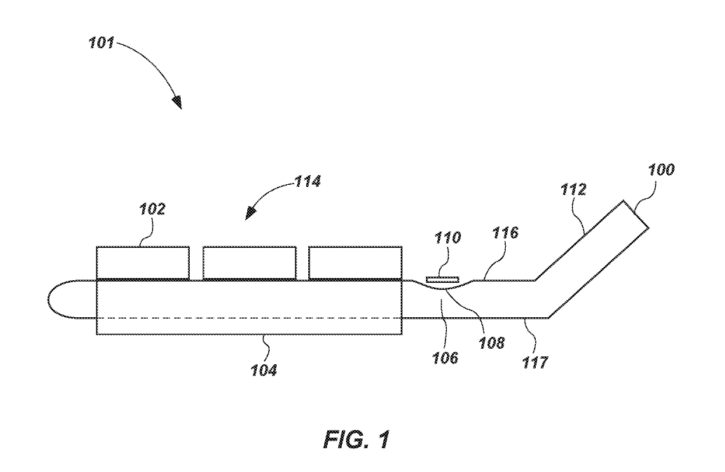

FIG. 1 illustrates a side view of an alignment fork 100 for a pallet dismantling system 101, according to one exemplary embodiment. The alignment fork 100 may comprise two cantilevers 106a, 106b (collectively cantilevers 106), and a pair of ramps 112a, 112b (collectively ramps 112) respectively to be positioned at second ends (collectively second ends) of the cantilevers 106. The cantilevers 106 comprise upper contact surfaces 116 (collectively upper contact surfaces 116) that form or lie planar to an open contact plane, lower contact surfaces 117 (collectively lower contact surfaces 117), first ends (collectively first ends), and second ends.

The open contact plane is a two-dimensional flat zone that lies planar with the upper contact surfaces 116 of the cantilevers 106 and is open to allow the stringers to pass through. In other words, the plane where the upper contact surfaces 116 lie is open space except for the upper contact surfaces 116. The contact plane is not bounded by the cantilevers, but rather extends to either side. For example, stringers of a pallet that are positioned to either side of the cantilevers 106 are considered to extend through the contact plane as are any stringers that are positioned between the cantilevers 106. When the upper contact surfaces 116 abut a deckboard surface coupled to one or more stringers of the received pallet, it causes a junction between the deckboard surface and the one or more stringers to be in-line with the contact surfaces.

The alignment fork 100 may further include a cutting tool guide 108. The cutting tool guide 108 may be a cutaway or divot in one or more of the cantilevers 106a, 106b. A cutting tool 110 may be positioned within the cutting tool guide 108, coplanar or otherwise parallel to the contact surfaces 116 of the cantilevers 106. Not shown in this image is a frame that holds the alignment fork 100 in an elevated position. All rigid horizontal attachment points that connect the base with the alignment fork 100 may be above the plane parallel to and in line with the lower contact surfaces 117 of the cantilevers 106 to permit a pallet 114 to pass through the pallet dismantling system 101.

Also shown in FIG. 1 is a pallet 114. The pallet 114 includes one or more top deckboards 102 and one or more stringers 104. The pallet may also include one or more bottom deckboards (not shown). The top deckboards 102 comprise bottom surfaces, and the stringers 104 comprise top sides that are coupled to the bottom surfaces of the top deckboards 102 to form a junction. The stringers 104 may also have lower contact surfaces (not shown) that are coupled to the upper contact surfaces (not shown) of the bottom deckboards (not shown).

An operator may load a pallet 114 onto the alignment fork 100 by inserting the cantilevers 106 between the top and bottom deckboards (e.g., top deckboards 102) of the pallet 114. The first ends of the cantilevers 106 may be angled, rounded, or tapered to assist in inserting the pallet 114. The upper contact surfaces 116 of the cantilevers 106 may abut one or more top deckboards 102 of a received pallet 114, thereby supporting the pallet 114 in an elevated position. Due to the elevated position, the bottom surfaces of the top deckboards 102 may lie flush with the upper contact surfaces 116 of the cantilevers 106 as well as with the open contact plane. When the pallet 114 is loaded onto the alignment fork 100, the stringers 104 of the pallet 114 extend through the open contact plane such that the top sides of the stringers 104 lie flush with, coplanar to, or parallel to the open contact plane.

When positioned on the alignment fork 100, the coupling between the bottom surfaces of top deckboards 102 and the top side of the stringers rests coplanar to and in line with the open contact plane. The cutting tool guide 108 may align the cutting tool 110 with the junction or coupling between the bottom surfaces of the top deckboards 102 and the top side of the stringers 104, such that the cutting tool 110 is positioned to be planar to the upper contact surfaces 116 of the cantilevers 106 at a point along the alignment fork 100. In one embodiment, a divot or recess in the cantilevers 106 may form the cutting tool guide 108. In another embodiment, an aperture in the cantilevers 106 may form the cutting tool guide 108. The cutting tool guide 108 may be shaped and configured to receive the cutting tool 110. For example, the depth of the divot may be shaped to allow the cutting tool 110 to be positioned flush with or otherwise coplanar to the upper contact surfaces 116 of the cantilevers 106. The cutting tool 110 that is flush with the upper contact surfaces 116 of the cantilevers 106 is positioned slightly below the bottom surfaces of the top deckboards 102 of the incoming pallet 114, making the cutting tool 110 in line with the coupling between the bottom surfaces of the top deckboards 102 and the top side of the stringers 104. When the cutting tool 110 is aligned with the coupling between the bottom surfaces of the top deckboards 102 and the top side of the stringers 104 by means of the cutting tool guide 108, less operator involvement is needed to align the cutting tool 110 with the junction where the deckboards 102 couple to the stringers 104.

In one embodiment, a mount within the cutting tool guide 108 may secure and provide support for the cutting tool 110. The mount may connect the cutting tool 110 to the cutting tool guide 108 and/or the cantilevers 106. In another embodiment, the cutting tool 110 may be part of an external machine. An operator may position the alignment fork 100 and the cutting tool 110 so that the cutting tool 110 is within the cutting tool guide 108 and flush and/or coplanar with the upper contact surfaces 116 of the cantilevers 106. The cutting tool guide 108 can reduce a need for cutting tool 110 realignment.

Cutting tools 110 may be any powered or unpowered means for separating and/or removing materials at a specified location. Cutting tools 110 may include a sharp edge, a bandsaw, a reciprocating saw, a powered hacksaw, a friction cutting saw, an abrasive water jet, a plasma cutter, a rolling cutter, a circular saw, or an abrasive cutoff disk. The pallet dismantling system 101 may record data about the status of the cutting tool 110, its condition, and efficiency. The pallet dismantling system 101 may inform an operator of needed maintenance based on the recorded data.

An operator may force the pallet 114 along the cantilevers 106. As the pallet 114 moves across the cutting tool 110, the cutting tool 110 may cut the nails that are holding the pallet 114 together while preserving the wood. The whole pallet 114 may be passed through the alignment forks 100. As each top deckboard 102 passes over the cutting tool 110, the cutting tool 110 may separate the top deckboards 102 from the stringers 104.

The ramps 112 may divert the separated top deckboards 102 and stringers 104 to respective collection areas. For example, as the pallet 114 is moved through the alignment forks 100, the pallet 114 may push the separated top deckboards 102 up the ramps 112. At the top of the ramps 112 a collection area may receive and retain the separated top deckboards 102. As shown, the ramps 112 may be a part of the cantilevers 106 via contact with the second ends of the cantilevers 106. It may also be possible to have the ramps 112 simultaneously divert the top deckboards 102 to a collection area and a partially dismantled pallet (now comprising stringers 104 and bottom deckboards) to another area for further dismantling. In an alternative embodiment, the ramps 112 may be an attachment that may optionally be used with the cantilevers 106.

Although the description for FIG. 1 mentions that the pallet 114 is oriented such that the top deckboards 102 are flush with the upper contact surfaces 116 of the cantilevers 106, and that the cutting tool 110 is level with the coupling between the bottom surfaces of the top deckboards 102 and the top side of the stringers 104, it should be understood that the inverse orientation is also possible. Specifically, the alignment fork 100 could be loaded with a pallet 114 that has the bottom deckboards resting on the cantilevers 106 such that the bottom deckboards are flush with the upper contact surfaces 116 of the cantilevers 106, and that the cutting tool 110 is level with the junction or coupling between the upper surface of the bottom deckboards and the lower contact surfaces of the stringers 104.

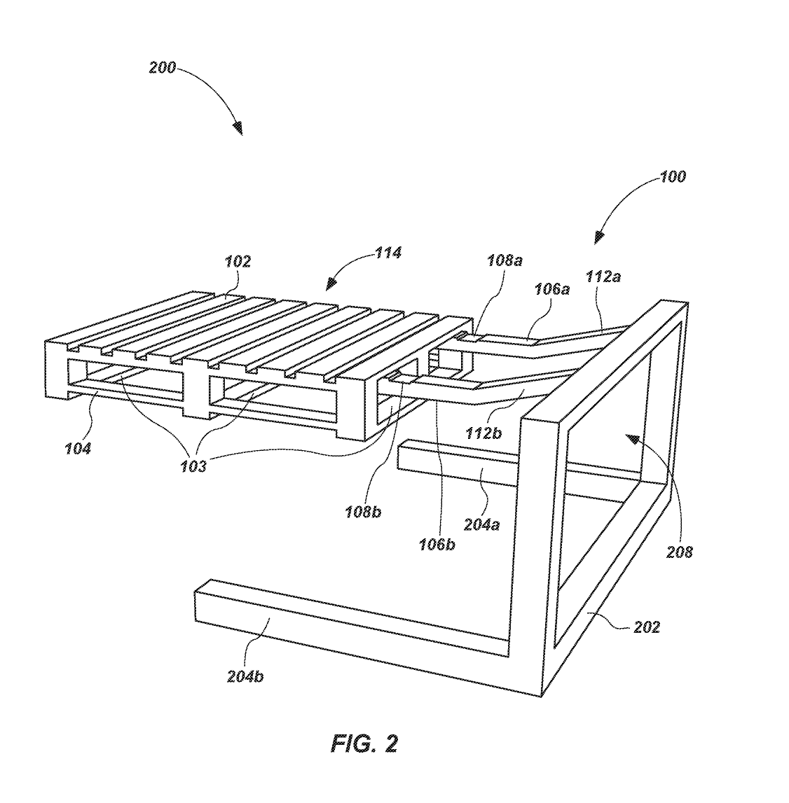

FIG. 2 illustrates a pallet dismantling system 200 with an alignment fork 100 to guide a pallet 114, according to one exemplary embodiment. As shown, the alignment fork 100 may have a first end (the first ends of the cantilevers 106), and a second end that is attached to a frame 202. The frame 202 may support the alignment fork 100 in an elevated position. Further, the frame 202 may be configured to keep the pallet dismantling system 200 in an elevated position when a pallet 114 is loaded onto the alignment fork 100. According to one embodiment, the alignment fork 100 may raise and lower to assist with the loading of pallets 114.

The frame 202 may allow a pallet 114 to pass through the pallet dismantling system 200. For example, as shown the frame 202 may form an opening 208 behind the cantilevers 106 that is sufficiently wide to allow at least a portion of a received pallet 114 to pass through. The opening 208 may be wider than the pallet 114. Thus, as the pallet 114 is pushed through the pallet dismantling system 200, the stringers 104 and bottom deckboards 103 may be guided through the opening 208, while the ramps 112 divert the top deckboards 102 to a separate collection area. Further, the pallet dismantling system 200 may include a first and second frame support leg 204a, 204b (collectively frame support legs 204) that allows the frame 202 to stand perpendicular to the ground, and the cantilevers 106 to be in an elevated position parallel to the ground and perpendicular to the frame 202. In alternative embodiments, the frame 202 may be attached directly to another surface, such as a floor, a table, or the like, thereby eliminating the need for frame support legs 204.

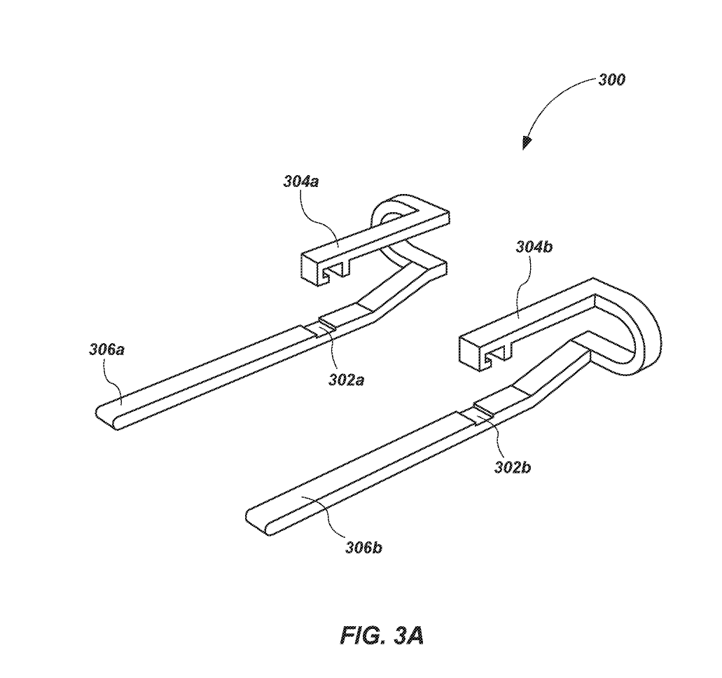

FIG. 3A and FIG. 3B illustrate an alignment fork 300 to retrofit existing pallet dismantling systems or bandsaw tables, according to one exemplary embodiment. In FIG. 3A, only the alignment fork 300 is shown, while FIG. 3B shows the alignment fork 300 positioned around an exemplary existing bandsaw table 308. As shown in both FIG. 3A and FIG. 3B, the alignment fork 300 may include a first and second cantilever 306a, 306b, where each cantilever 306a, 306b includes upper contact surfaces (collectively contact surfaces), a cutting tool guide 302a, 302b, a mounting bracket 304a, 304b, and a ramp. FIG. 3B illustrates a bandsaw table 301 with a table 308, a bandsaw 312, and a support structure 310, where the table 308, bandsaw 312, and support structure 310 are all positioned parallel to each other. Also shown in FIG. 3B is a pallet 114 similar to the pallet 114 of FIG. 1, where the pallet 114 has top deckboards 102, bottom deckboards 103, and stringers 104.

The alignment fork 300 is configured such that the mounting brackets 304a, 304b may attach the alignment fork 300 to the support structure 310 of the bandsaw table 301. An operator may align the bandsaw 312 with the blade guides 302a, 302b, such that the bandsaw 312 is flush or otherwise coplanar with the contact surfaces of the cantilevers 306a, 306b, thereby aligning the bandsaw 312 with the coupling between the bottom surfaces of the top deckboards 102 and the top side of the stringers 104 of a loaded pallet 114.

An operator may insert the cantilevers 306a, 306b in between the top and bottom deckboards 102, 103 of a pallet 114. The pallet's top deckboards 102 may slide along the contact surfaces of the cantilevers 306a, 306b. Further, the contact surfaces of the cantilevers 306a, 306b support the entire pallet 114 via contact with the top deckboards 102, such that the pallet 114 is in an elevated position above the table 308 of the bandsaw table 301. Because the bandsaw 312 is aligned with the contact surfaces of the cantilevers 306a, 306b, as the operator slides the pallet 114 through the bandsaw 312, the bandsaw 312 cuts through the junction in line with the coupling between the bottom surfaces of the top deckboards 102 and the top side of the stringers 104. Thus, the bandsaw 312 separates all the deckboards on one side of the pallet 114 during a pass.

The separated top deckboards 102 and stringers 104 may pass all the way through for collection on the other side. The ramps may assist with diverting the separated top and bottom deckboards 102, 103 from the stringers 104. For example, on a first pass with a complete pallet 114, the bandsaw 312 may separate the top deckboards 102 from the stringers 104 as the operator pushes the pallet 114 all the way through to the other side of the alignment fork 300. The ramps may push the separated top deckboards 102 to a different location than the stringers 104 with the bottom deckboards 103 (partially dismantled pallet). The separated top deckboards 102 and the partially dismantled pallet may be retrieved separately on the other side of the alignment fork 300. The partially dismantled pallet may then be passed back to the front of the alignment fork 300 and flipped over to be completely dismantled with a second pass.

In one embodiment, a collection bin, chute or conveyor belt may catch the separated top and/or bottom deckboards 102, 103 that pass over the alignment fork 300. In such an embodiment, when an operator passes the pallet 114 through the alignment fork 300, the separated top and/or bottom deckboards 102, 103 may be automatically collected on the other side. In some embodiments, the collection bin, chute, shunts, or conveyor belt may be configured to stack the top and/or bottom deckboards 102, 103. A collection bin may be removable. In some embodiments, chutes and shunts may be controlled by actuators, to continuously or periodically sort, buffer, and/or move top and/or bottom deckboards 102, 103 to a collection area for further processing. The chutes and shunts may be under automatic or operator control. Collection areas may have visible, auditory or electronic indications to report to an operator or other system the quantity of material in a collection area, the remaining capacity, a history, and/or an estimate of time until full.

The cantilevers 306a, 306b may be adjustable. For example, an operator may change the position of the cantilevers 306a, 306b to adjust the distance between the cantilevers 306a, 306b. The distance between the cantilevers 306a, 306b may affect the side-to-side travel of a pallet 114. In one embodiment, the height of each cantilever 306a, 306b may be fixed. In another embodiment, the height of each cantilever 306a, 306b may be adjustable to compensate for variations in arch height in different machines.

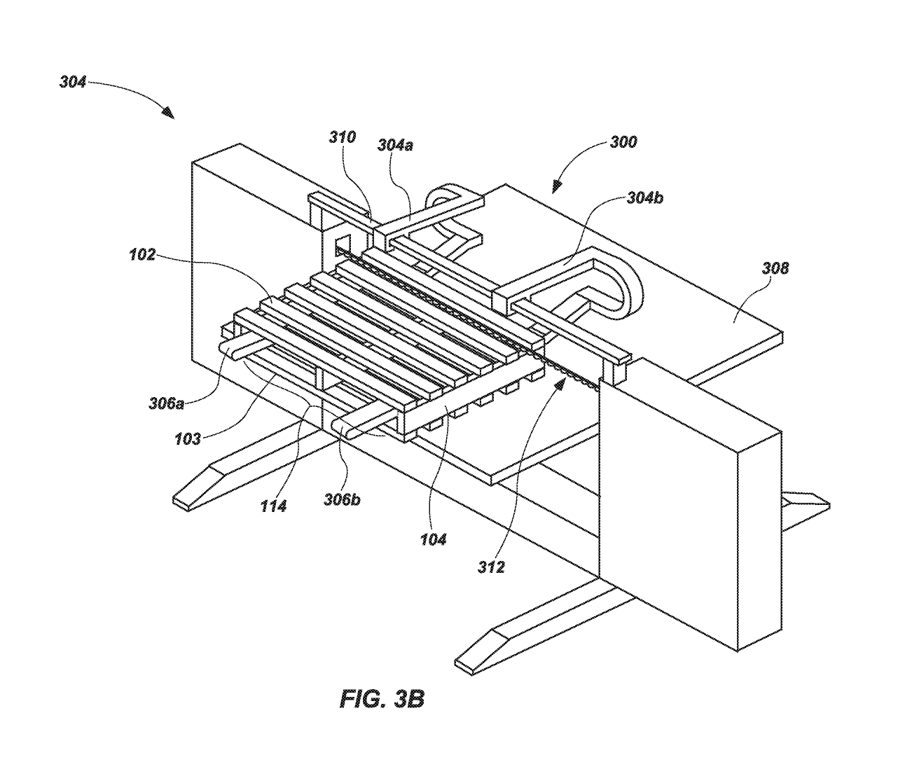

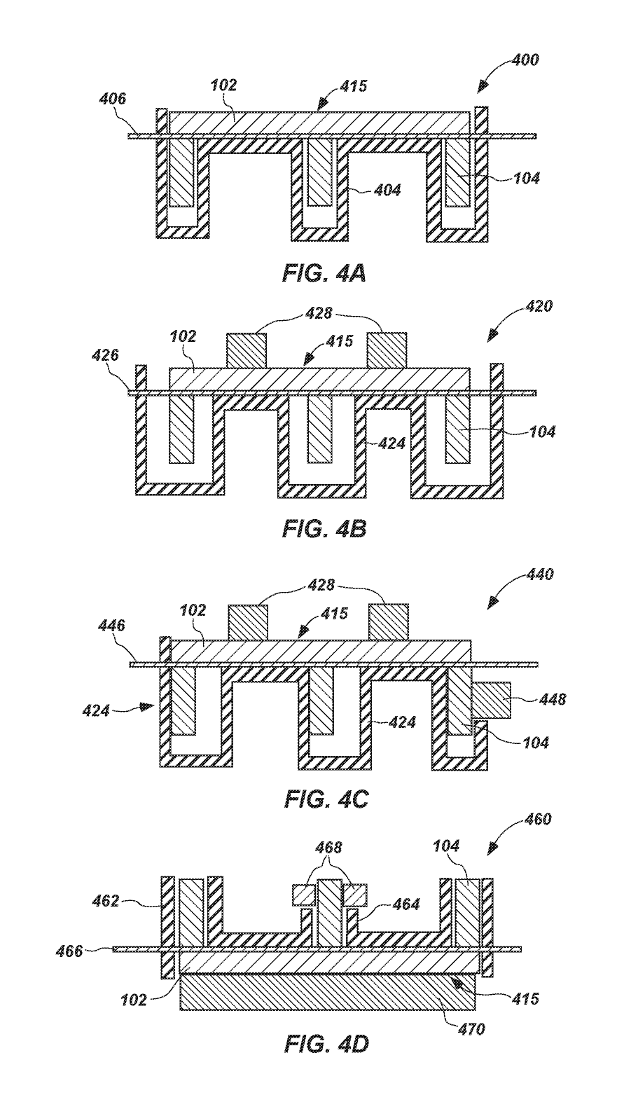

FIGS. 4A-4D illustrate several exemplary guide chutes for a pallet dismantling system. As shown, a combination of chutes, skids, clamps, actuators and/or rollers may be used to guide or at least partially limit the movement of a partially dismantled pallet. Guide chutes may be used in combination with alignment forks for a complete pallet dismantling system. Chutes may also have tapered profiles and ends that facilitate partially dismantled pallet acceptance, and may contain recessed portions or holes to allow and/or guide cutting tools to be aligned with the space between the stringers 104 and the deckboards 102. As shown in each of FIG. 4A-4D, deckboards 102 of a partially dismantled pallet 415 lie flush with the walls of the chute. The deckboards 102 shown are understood to be top deckboards 102, and the bottom deckboards (not shown) are already removed. It should be understood also that an inverse orientation is possible, wherein the bottom deckboards are still a part of a partially dismantled pallet 415, while the top deckboards 102 are already removed.

In one embodiment, an actuator or conveyor belt system may move the partially dismantled pallet 415 toward the cutting tool. In another embodiment, an operator may push the partially dismantled pallet 415. In yet another embodiment, the next partially dismantled pallet 415 to be disassembled may be pushed by another partially dismantled pallet 415.

Skids and actuators may use hinges, springs, pneumatics, clamps, and/or gravity to provide a force to a component in one or more directions. The magnitude, force profile, damping, limits, and the direction of forces applied may be adjustable. In the descriptions for FIGS. 4A-4D, the term “vertical” is understood to be the direction perpendicular to the contact surfaces of the deckboards of the pallet. The term “lateral” is understood to be the direction parallel to the contact surfaces of the deckboards of the pallet. The term “longitudinal” is understood to be the direction perpendicular to the cross section of the pallet, or the cross section of the chute.

According to FIG. 4A, in one embodiment, a simple chute 400 may guide a partially dismantled pallet 415. The simple chute 400 may comprise rigid sidewalls 404 sized and spaced to receive the stringers 104 of a partially dismantled pallet 415 and to support the deckboards 102 of the partially dismantled pallet 415. A cutting tool 406 may be aligned with the junction at the coupling between the bottom surfaces of the deckboards 102 and the top side of the stringers 104. Gravity may hold the deckboards 102 to the chute 400, and the rigid sidewalls 404 that surround the stringers 104 may prevent or limit lateral movement of the partially dismantled pallet 415.

FIG. 4B illustrates another embodiment of a simple chute 420 that may guide a partially dismantled pallet 415. The chute 420 may comprise rigid sidewalls 424, a cutting tool 426, and vertical skids 428 that may limit the vertical movement of the partially dismantled pallet 415. As shown, the rigid sidewalls 424 of the chute 420 may be spaced to accommodate some lateral movement of the partially dismantled pallet 415. The vertical skid 428 may be a flat or curved surface that provides a force in one or more directions. For example, the vertical skid 428 may provide a vertical force that pushes the partially dismantled pallet 415 toward the chute 420. In some embodiments, the vertical skid 428 may provide a limited force that reduces vertical movement of the partially dismantled pallet 415 while allowing longitudinal movement of the partially dismantled pallet 415. To assist longitudinal movement of the partially dismantled pallet 415, the end of the vertical skid 428 that contacts the partially dismantled pallet 415 may have bearings, rollers, or an anti-friction coating. In another embodiment, the vertical skid 428 may also provide a longitudinal force and guide the partially dismantled pallet 415 toward the cutting tool 426. In some embodiments, the vertical skids 428 may push against the partially dismantled pallet 415 via an appropriate clamping mechanism.

FIG. 4C illustrates a chute 440 with rigid sidewalls 424c, vertical skids 428, a cutting tool 446, and a lateral skid 448 that may limit the lateral movement of the partially dismantled pallet 415. As illustrated, the lateral skid 448 may push against an outer wall of an exterior stringer 104 such that the whole partially dismantled pallet 415 is shifted until each stringer is in contact with a rigid sidewall 424 of the chute 440, thereby limiting the lateral movement of the partially dismantled pallet 415.

The lateral skid 448 may be a flat or curved surface that provides a force in one or more directions. For example, the lateral skid 448 may provide a longitudinal force that pushes the partially dismantled pallet 415 toward the chute 420. In some embodiments, the lateral skid 448 may provide a limited force that reduces lateral movement of the partially dismantled pallet 415 while allowing longitudinal movement of the partially dismantled pallet 415. To assist longitudinal movement of the partially dismantled pallet 415, the end of the lateral skid 448 that contacts the partially dismantled pallet 415 may have bearings, rollers, or an anti-friction coating. In another embodiment, the lateral skid 448 may also provide a longitudinal force and guide the partially dismantled pallet 415 toward the cutting tool 426. In some embodiments, the lateral skid 448 may push against the partially dismantled pallet 415 via a clamping mechanism.

FIG. 4D illustrates another embodiment of a chute 460 including rigid sidewalls 462, 464, a cutting tool 466, a broad skid 470, and actuators 468. The rigid sidewalls 462 are positioned to secure a partially dismantled pallet 415 via contact with the exterior stringers 104 and lateral sides of the deckboards 102. The rigid sidewalls 464 are also positioned to secure the partially dismantled pallet 415 via contact with each stringer 104 and the deckboards 102. The actuators 468 may grip a pallet stringer 104 while the broad skid 470 provides an upward vertical force to hold the partially dismantled pallet 415 against the chute 460. The actuator 468 may be a powered wheel, cylinder, belt, chain conveyor, piston, multidirectional wheel, frame, or arm. An actuator 468 may grip and provide a longitudinal force to the partially dismantled pallet 415 to move the partially dismantled pallet 415 toward the cutting tool 466. A computing system may automatically control the force, position, velocity, or acceleration of the actuator 468. For example, the computing system may sense when a deckboard 102 is being dismantled by the cutting tool 466 and slow down the movement of the partially dismantled pallet 415 to ensure an accurate cut and preserve the condition of the cutting tool 466. In some embodiments, the broad skid 470 may provide a limited force that reduces vertical movement of the partially dismantled pallet 415 while allowing longitudinal movement of the partially dismantled pallet 415. To assist longitudinal movement of the partially dismantled pallet 415, the end of the broad skid 470 that contacts the partially dismantled pallet 415 may have bearings, rollers, or an anti-friction coating. In another embodiment, the broad skid 470 may also provide a longitudinal force and help guide the partially dismantled pallet 415 toward the cutting tool 426. In some embodiments, the broad skid 470 may push against the partially dismantled pallet 415 via a clamping mechanism.

Referring to FIGS. 4A-4D collectively, the chute 400, 420, 440, 460 can also be used with an alignment fork, such as the alignment fork 100 of FIG. 1 and FIG. 2. In such an application, the chute 400, 420, 440, 460 may assist in limiting the movement of the partially dismantled pallet 415, and the alignment fork 100 may keep the partially dismantled pallet 415 in an elevated position and aid with the alignment of the cutting tool 406, 426, 446, 466.

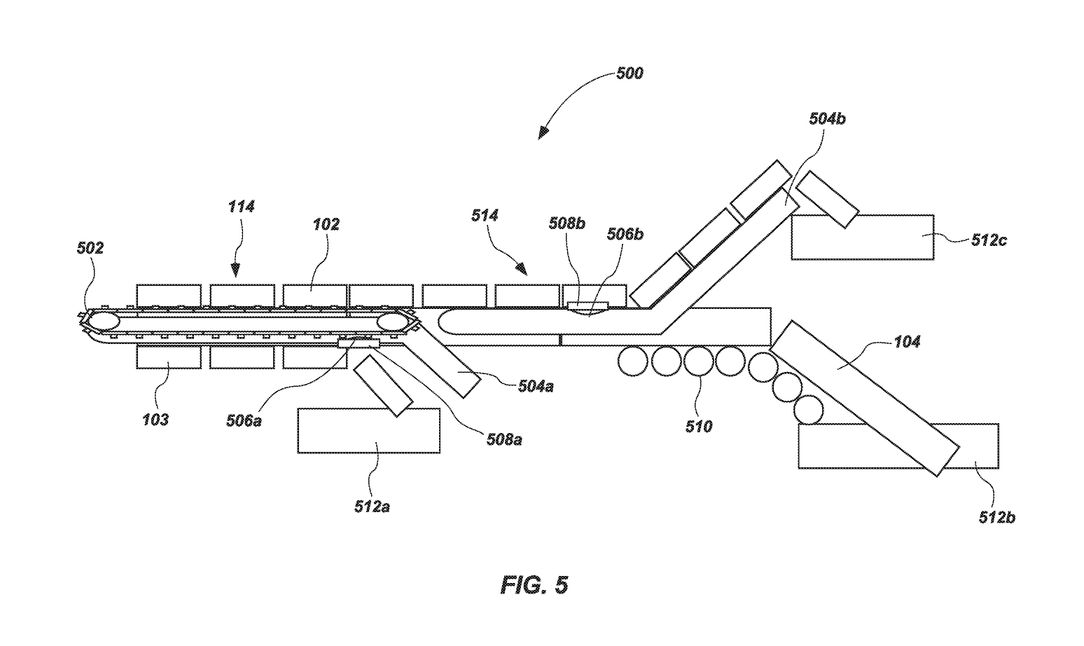

FIG. 5 illustrates an automated pallet dismantling system 500, according to one exemplary embodiment. As shown, the automated pallet dismantling system 500 may comprise a conveyor belt 502, rollers 510, a first, second, and third collection area 512a, 512b, 512c, and a first and second alignment fork 504a, 504b. Also shown is a complete pallet 114 comprising top deckboards 102, bottom deckboards 103, and stringers 104, as well as a partially dismantled pallet 514 comprising only stringers 104 and either top deckboards 102 or bottom deckboards 103. The first and second alignment forks 504a, 504b may each include a first or second cutting tool guide 506a, 506b respectively, and a first or second cutting tool 508a, 508b respectively.

In FIG. 5, it is shown that the partially dismantled pallet 514 comprises only top deckboards 102 and stringers 104, but it should be understood that the inverse is also possible, where the partially dismantled pallet 514 comprises only bottom deckboards 103 and stringers 104.

The conveyor belt 502 may support and slide a received pallet 114 along the first alignment fork 504a. In one embodiment, the conveyor belt 502 may be positioned higher than the first alignment fork 504a causing the bottom deckboards 103 of the pallet 114 to be flush with the surface of the first alignment fork 504a that includes the first cutting tool guide 506a and cutting tool 508a. The height of the conveyor belt 502 may be adjustable to accommodate variation in pallets 114. In another embodiment, the conveyor belt 502 may be embedded in the first alignment fork 504a. The embedded conveyor belt 502 may protrude above the first alignment fork 504a to cause the bottom deckboards 103 of a pallet 114 to be flush with the surface of the first alignment fork 504a that includes the first cutting tool guide 506a and cutting tool 508a.

As the conveyor belt 502 slides the pallet 114 along the first alignment fork 504a, the first cutting tool 508a may separate the bottom deckboards 103 from the stringers 104. The first cutting tool guide 506a may position the first cutting tool 508a to be coplanar or otherwise flush with the bottom surface of the first alignment fork 504a, thereby causing the first cutting tool 508a to be aligned with the coupling between the lower contact surface 123 of the stringers 104 and the upper contact surface 121 of the bottom deckboards 103.

After the conveyor belt 502 has slid the pallet 114 along the first alignment fork 504a, the separated bottom deckboards 103 may be sent to the first collection area 512a. The first collection area 512a may be a bin, chute, or conveyor system. As shown, the bottom deckboards 103 may drop into the first collection area 512a. In alternative embodiments, a slide or rollers may be used to transfer the bottom deckboards 103 to the first collection area 512a.

After the conveyor belt 502 has slid the received pallet 114 along the first alignment fork 504a, the partially dismantled pallet 514 may be received by the second alignment fork 504b. In an alternative embodiment, the second alignment fork 504b may be utilized in combination with a guide chute, such as the guide chute 400, 420, 440, 460 illustrated in FIGS. 4A-4D. The second alignment fork 504b may be configured with the second cutting tool guide 506b and second cutting tool 508b on the top side to separate the top deckboards 102 from the stringers 104. The partially dismantled pallets 514 may be forced through the second alignment fork 504b by contact with the pallets 114 remaining on the conveyor belt 502. In one embodiment, the continual addition of new pallets 114 at the front end of the automated pallet disassembly system 500 pushes the partially dismantled pallets 514 through the second alignment fork 504b. In alternative embodiments a second conveyor belt may slide the pallets 114 along the second alignment fork 504b. After the second cutting tool 508b separates the top deckboards 102 from the stringers 104, the rollers 510 may guide the stringers 104 to the second collection area 512b, and the top deckboards 102 may be pushed into the third collection area 512c.

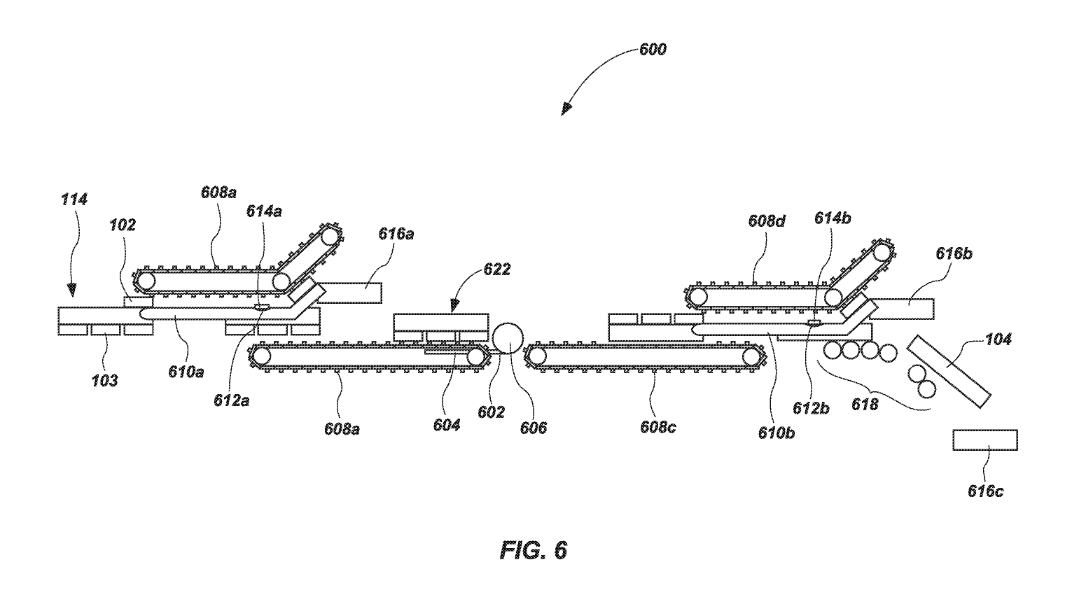

FIG. 6 illustrates an automated pallet dismantling system 600 with a pivoting arm actuator 602, according to one exemplary embodiment. As shown, a first, second, third, and fourth conveyor belt 608a, 608b, 608c, 608d respectively may slide a set of pallets 114 or partially dismantled pallets 622 along a first and second alignment fork 610a, 610b, and the pivoting arm actuator 602 may invert each pallet 114 after it passes through the first alignment fork 610a. The pivoting arm actuator 602 may facilitate maintaining the top and bottom deckboards 102, 103 flush with the surface of the first and second alignment forks 610a, 610b. In each cantilever of each alignment fork 610a, 610b, a cutting tool 614a, 614b may be positioned within the cutting tool guides 612a, 612b such that the cutting tool 614a, 614b runs transverse to the cantilevers.

The first alignment fork 610a may receive a pallet 114. The top deckboards 102 of the pallet 114 may rest on the surface of the first alignment fork 610a. The top deckboards 102 may be held flush with the surface of the first alignment fork 610a via gravity. The first conveyer belt 608a may be positioned above a received pallet 114. The first conveyer belt 608a may slide the received pallet 114 along the first alignment fork 610a and limit vertical movement of the received pallet 114. As the first conveyor belt 608a slides the received pallet 114 along the first alignment fork 610a, a first cutting tool 614a in a first cutting tool guide 612a may separate the top deckboards 102 from the stringers 104. The conveyer belt 608a and alignment fork 610a may assist with aligning the cutting tool 614a with the junction at a coupling between the bottom surfaces of the top deckboards 102 and the top side of the stringers 104 of the pallet 114. The first conveyor belt 608a may move the separated top deckboards 102 to a first collection area 616a, and the second conveyor belt 608b may receive the partially dismantled pallet 622.

The second conveyor belt 608b may move the partially dismantled pallet 622 to the pivoting arm actuator 602. The pivoting arm actuator 602 may comprise an arm 604 and a pivot point 606. The arm 604 may be configured to lift the partially dismantled pallet 622. For example, in some embodiments the arm 604 may be more than half as long as the partially dismantled pallet 622 so that the center of gravity of the partially dismantled pallet 622 is on the arm 604. In another embodiment, the arm 604 may have a hook to grasp between bottom deckboards 103.

The pivoting arm actuator 602 may rotate the arm 604 around the pivot point 606. A sensor may detect the presence of a partially dismantled pallet 622 and send a signal to the pivoting arm actuator 602. The pivoting arm actuator 602 may pivot the arm 604 in response to the signal. The arm 604 may flip the partially dismantled pallet 622 onto the third conveyor belt 608c with the bottom deckboards 103 above the stringers 104. The third conveyor belt 608c may move the partially dismantled pallet 622 onto the second alignment fork 610b.

The bottom deckboards 103 of the partially dismantled pallet 622 may rest on the surface of the second alignment fork 610b. The bottom deckboards 103 may be held coplanar with or otherwise flush to the surface of the second alignment fork 610b via gravity. The fourth conveyer belt 608d may be positioned above the partially dismantled pallet 622. The fourth conveyer belt 608d may move the partially dismantled pallet 622 along the alignment fork 610b and limit vertical movement of the partially dismantled pallet 622. As the fourth conveyor belt 608d moves the partially dismantled pallet 622 through the second alignment fork 610b, a second cutting tool 614b in a second cutting tool guide 612b may separate the bottom deckboards 103 from the stringers 104. The alignment fork 610b along with the third and fourth conveyer belts 608c, 608d may assist with aligning the second cutting tool 614b with the coupling between the upper contact surfaces 121 of the bottom deckboards 103 and the lower contact surfaces 123 of the stringers 104. The fourth conveyor belt 608d may move the separated bottom deckboards 103 to the second collection area 616b, and the stringers 104 may be led by rollers 618 to the third collection area 616c.

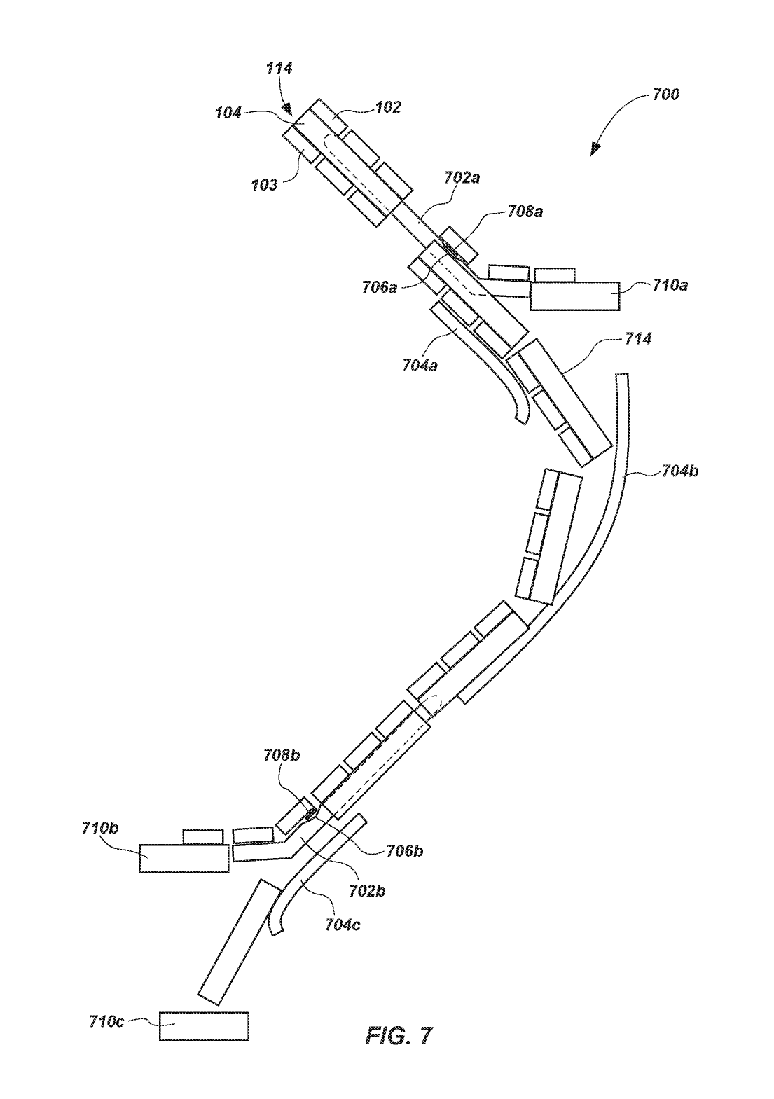

FIG. 7 illustrates a gravity fed pallet dismantling system 700, according to one exemplary embodiment. As shown, a first and second alignment fork 702a, 702b respectively and a first, second, and third deflecting barrier 704a, 704b, 704c may lead pallets 114 and partially dismantled pallets 714 through a pallet dismantling system 700.

The first alignment fork 702a may receive a pallet 114. The top deckboards 102 of the pallet 114 may lie flush with the surface of the alignment fork 702a due to gravitational forces. Further, the first alignment fork 702a may be angled such that gravitational force will cause the pallet 114 to slide along the first alignment fork 702a. Specifically, a first end of the first alignment fork 702a may be more elevated than the second end of the alignment fork 702a to generate a gravity assisted feed. A first cutting tool guide 706a may position a first cutting tool 708a coplanar or otherwise flush with the surface of the first alignment fork 702a, aligning the first cutting tool 708a with a junction at the coupling between the bottom surfaces of the top deckboards 102 and the top side of the stringers 104. As gravity forces the pallet 114 along the first alignment fork 702a, the first cutting tool 708a may separate the top deckboards 102 from the pallet 114.

A first collection area 710a may receive the separated top deckboards 102, and a first deflecting barrier 704a may collect the partially disassembled pallet 714 via contact with the bottom deckboards 103. The deflecting barriers 704a, 704b, 704c may be chutes, slides, or rollers. As shown the deflecting barriers 704a, 704b, 704c may have a curved profile that causes the bottom deckboards 103 to rotate above the stringers 104.

A second deflection barrier 704b may ensure that the second alignment fork 702b may receive the partially disassembled pallet 714. The bottom deckboards 103 of the partially disassembled pallet 714 may lie flush with the surface of the second alignment fork 702b due to gravitational forces. Similar to the first alignment fork 702a, the second alignment fork 702b may be angled such that gravitational force will cause the partially dismantled pallet 714 to slide along the second alignment fork 702b. Specifically, a first end of the second alignment fork 702b may be more elevated than the second end of the second alignment fork 702b to generate a gravity assisted feed. A second cutting tool guide 706b may position a second cutting tool 708b coplanar or otherwise flush with the surface of the second alignment fork 702b, aligning the second cutting tool 708b up with a junction at the coupling between the upper contact surfaces 121 of the bottom deckboards 103 and the lower contact surfaces 123 of the stringers 104. As gravity forces the partially disassembled pallet 714 along the second alignment fork 702b, the second cutting tool 708b may separate the bottom deckboards 103 from the pallet 714. A second collection area 710b may receive the separated bottom deckboards 103, and a third collection area 710c may receive the separated stringers 104.

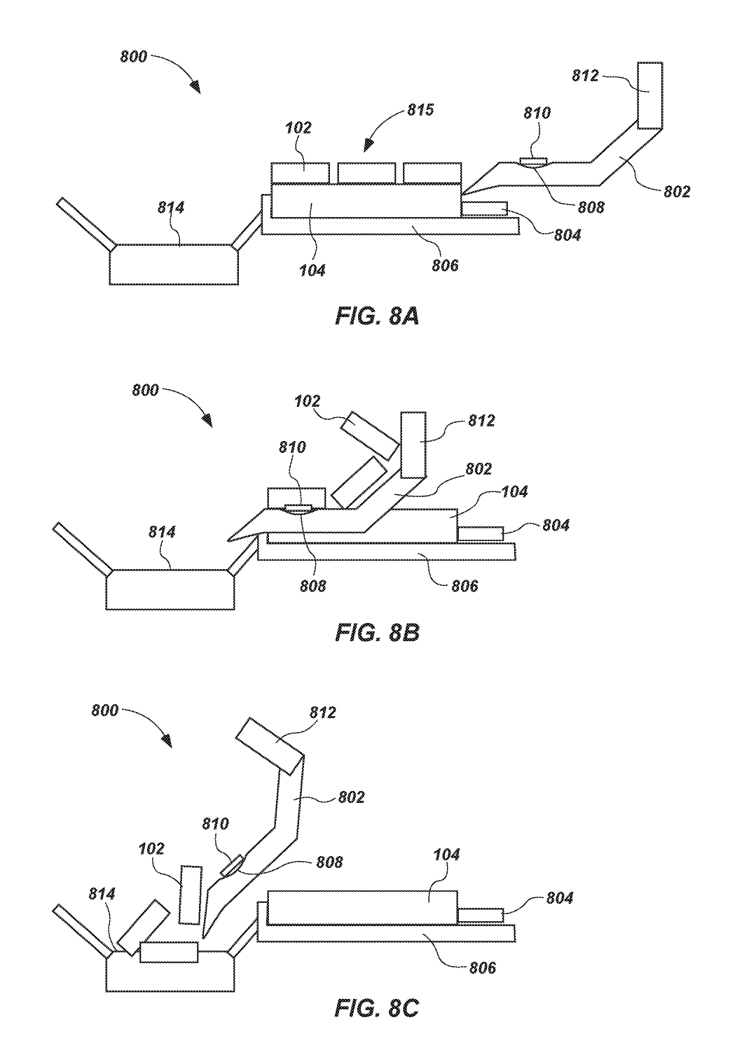

FIGS. 8A-8C illustrate a static pallet dismantling system 800, according to another embodiment. As shown, the static pallet dismantling system may comprise an alignment fork 802, a clamp 804, a chute 806, and a collection area 814. Also shown is a pallet 815 where top deckboards 102 and stringers 104 are visible. The alignment fork 802 comprises a cutting tool 810 and a cutting tool guide 808 that allows the cutting tool 810 to be positioned such that it lies coplanar to the upper contact surfaces of the cantilevers of the alignment fork 802, thereby allowing the cutting tool to be aligned with the junction at the coupling between the bottom surfaces of the top deckboards 102 and the upper surfaces of the stringers 104 of a received pallet 815. Further, the alignment fork 802 comprises a rear collector 812.

The static pallet dismantling system 800 may secure a pallet 815 immobile and move the alignment fork 802 and cutting tool 810 through the immobilized pallet 815. This may allow the length of the alignment fork 802 to be shorter because the alignment fork 802 does not need to support the pallet 815 as in other embodiments discussed previously.

The clamp 804 and the side of the chute 806 may hold the pallet 815 in place. The clamp 804 may provide a lateral force to the stringers 104 of the pallet 815 that pushes the pallet 815 against the side of the chute 806. The lateral force may apply a constant pressure to the stringer 104 to keep the pallet 815 secure. In some embodiments, an operator may set a desired force and the system may maintain the desired force. In another embodiment, the system 800 may automatically adjust the desired force based on the pallet 815 size. In yet another embodiment, the system 800 may automatically adjust the desired force based on the disassembly process. For example, the desired force may be low before the insertion of the alignment fork 802, and high while the cutting tool 810 is separating the top deckboards 102 from the stringers 104. The clamp 804 may be a skid, or any other suitable component.

As the alignment fork 802 and cutting tool 810 slide along the pallet 815, the cutting tool 810 separates the top deckboards 102 from the stringers 104. The cutting tool guide 808 may position the cutting tool 810 to be in line with junction at the coupling between the bottom surfaces of the top deckboards 102 and the top side of the stringers 104. For example, the cutting tool guide 808 may align the cutting tool 810 with the upper contact surfaces of the cantilevers of the alignment fork 802, and the alignment fork 802 may be configured to receive the top deckboards 102 of the pallet 815 on top of the upper contact surfaces of the cantilevers of the alignment fork 802. Thus, the cutting tool 810 is slightly below the top deckboards 102 in line with the coupling between the bottom surfaces of the top deckboards 102 and the top side of the stringers 104. An extra alignment slope may assist in the insertion of the alignment fork 802.

After the cutting tool 810 separates the top deckboards 102, the rear collector 812 of the alignment fork 802 may collect the top deckboards 102. The rear collector 812 of the alignment fork 802 may have a curved backing to collect the top deckboards 102. The alignment fork 802 may dump the top deckboards 102 in a collection area 814 then return to a starting position to receive another pallet 815 or the newly (inverted) partially dismantled pallet. The system may release the remaining stringers 104 and move them to another collection area.

It should be understood that although the description for FIG. 8 refers to top deckboards 102 and a full pallet 815, the inverse orientation is also possible. Specifically, it is possible that the static pallet dismantling system 800 be loaded with a pallet 815 such that the bottom deckboards 103 are positioned above the stringers 104, thereby allowing the alignment fork 802 to separate the bottom deckboards 103 from the stringers 104. It should also be understood that it is possible to load the static pallet dismantling system 800 with a partially dismantled pallet rather than a full pallet 815 to remove whichever of the top or bottom deckboards 102, 103 are still coupled to the stringers 104.

A method of dismantling a pallet may include positioning cantilevers of an alignment for through a pallet between upper deckboards and lower deckboards. The cantilevers may include a cutting tool guide to facilitate positioning of a cutting tool coplanar to an upper contact surface of the cantilevers. The pallet may be advanced along the cantilevers toward the cutting tool. The separated deckboards may be diverted to a collector.

The above description provides numerous specific details for a thorough understanding of the embodiments described herein. However, those of skill in the art will recognize that one or more of the specific details may be omitted, modified, and/or replaced by a similar process or system. Those having skill in the art will recognize that changes may be made to the details of the above-described embodiments without departing from the underlying principles of the present disclosure. Embodiments of the disclosure in which an exclusive property or privilege is claimed are defined as follows.

1. A pallet dismantling system comprising:
an alignment fork configured to be inserted into a pallet opening to receive a pallet at a first end, the alignment fork comprising cantilevers with contact surfaces that abut a deckboard surface coupled to one or more stringers of the received pallet causing a junction between the deckboard surface and the one or more stringers to be in-line with the contact surfaces;
a frame attached to a second end of the alignment fork to support the alignment fork in an elevated position;
a cutting tool positioned planar to the contact surfaces of the cantilevers at a point along the alignment fork, the cutting tool to separate the one or more stringers from the deckboard surface.

2. The pallet dismantling system of claim 1, wherein one or more of the cantilevers each comprise a cutting tool guide to facilitate positioning of the cutting tool.

3. The pallet dismantling system of claim 2, wherein the cutting tool guide is a divot.

4. The pallet dismantling system of claim 3, wherein the cutting tool is positioned within the divot coplanar with the contact surfaces of the cantilever.

5. The pallet dismantling system of claim 1, wherein the cutting tool is a reciprocating blade that runs transverse to the cantilevers and extends beyond the cantilevers.

6. The pallet dismantling system of claim 5, wherein the cantilevers comprise a set of in-line divots across each of the cantilevers, wherein the reciprocating blade is positioned within the divot coplanar with the contact surfaces of the cantilevers.

7. The pallet dismantling system of claim 1, wherein the frame comprises an opening sufficiently wide to allow the received pallet to pass through.

8. The pallet dismantling system of claim 1, wherein the alignment fork further comprises a ramp to divert one or more deckboards separated from the one or more stringers.

9. The pallet dismantling system of claim 1, further comprising a clamp to limit movement of the received pallet.

10. The pallet dismantling system of claim 9, wherein the clamp comprises a skid to limit movement of the pallet while allowing the received pallet to slide along the alignment fork.

11. The pallet dismantling system of claim 1, further comprising a conveyer belt to slide the received pallet along the alignment fork.

12. The pallet dismantling system of claim 11, wherein the first end of the alignment fork is more elevated than the second end of the alignment fork to generate a gravity assisted feed.

13. An alignment fork for a pallet dismantling system comprising:
a set of cantilevers comprising contact surfaces that abut a deckboard surface coupled to one or more stringers of a received pallet causing a junction between the deckboard surface and the one or more stringers to be coplanar with the contact surfaces wherein set of the cantilevers are configured to couple to a support structure,
a blade guide on one or more of the cantilevers of the set of cantilevers to receive a cutting tool and facilitate alignment of the cutting tool with the contact surfaces.

14. The alignment fork of claim 13, wherein the blade guide is a divot.

15. The alignment fork of claim 14, wherein the blade guide facilitates placement of the cutting tool within the divot coplanar with the contact surfaces of the cantilevers to align the cutting tool with the junction of deckboard surface and the one or more stringers when the received pallet is slid along the set of cantilevers.

16. The alignment fork of claim 13, wherein the blade guide receives a cutting tool that is a reciprocating blade that runs transverse to the set of cantilevers and extends beyond the set of cantilevers.

17. The alignment fork of claim 16, wherein the set of cantilevers comprise in-line divots across each of the cantilevers, wherein the reciprocating blade is positioned within the divot parallel with the contact surfaces of the cantilevers.

18. The alignment fork of claim 13, wherein the set of cantilevers further comprises one or more mounting brackets coupled to the set of cantilevers to selectively couple the set of cantilevers to a support structure.

19. The alignment fork of claim 13, further comprising a clamp to limit movement of the received pallet.

20. The alignment fork of claim 19, wherein the clamp comprises a skid to limit movement of the pallet while allowing the received pallet to slide along the alignment fork.
